(19) United States
(12) Patent Application Publication
(10) Pub. No.: US 2015/0359045 A1
(43) Pub. Date: Dec. 10, 2015

(54) AN INDUCTION MODULE FOR AN INDUCTION COOKING HOB

(71) Applicant: ELECTROLUX HOME PRODUCTS CORPORATION N.V., Brussels (BE)

(72) Inventors: Alwin Neukamm, Rothenburg ob der Tauber (DE); Harald Hoffmann, Rothenburg ob der Tauber (DE); Björn Leyh, Rothenburg ob der Tauber (DE); Ulrich HÄUTLE, Rothenburg ob der Tauber (DE)

(73) Assignee: Electrolux Home Products Corporation N. V., Brussels (BE)

(21) Appl. No.: 14/758,693

(22) PCT Filed: Jan. 9, 2014
(86) PCT No.: PCT/EP2014/050275

§ 371 Date: Jun. 30, 2015

(30) Foreign Application Priority Data
Jan. 25, 2013 (EP) 13152620.4

(51) Int. Cl. H05B 6/12

(52) U.S. Cl. CPC H05B 6/12; H05B 6/1209

(57) ABSTRACT

An induction module for an induction cooking hob including a metal induction coil carrier for supporting at least one induction coil and a housing made of plastics for covering and/or enclosing the at least one induction coil. The housing is fixed or fixable to a bottom side of the induction coil carrier includes a bottom wall, one or more side walls and an open top side. At least one hook element is formed at one or more side walls of the housing. The induction coil carrier includes a horizontal main panel and at least one vertical sheet element containing at least one cut-out and extending downwards from the horizontal main panel. The hook element and the corresponding cut-out form a snap-in mechanism for fixing the housing to the induction coil carrier wherein the side wall of the housing is adjacent to the corresponding vertical sheet element of the induction coil carrier.

The present invention relates to induction module for an induction cooking hob. Further, the present invention relates to an induction cooking hob comprising at least one induction module.

An induction cooking hob includes usually an induction coil carrier made of steel and a housing made of plastics. The induction coil carrier is provided for supporting one or more induction coils. The housing covers or encloses said induction coil or induction coils, respectively. The housing is usually fixed to the induction coil carrier by a plurality of screws.

However, the fixation of the housing to the induction coil carrier by the screws means a big expenditure and labour. This results in high costs for assembling the induction module and the associated induction cooking hob.

It is an object of the present invention to provide an induction module for an induction cooking hob, which allows an assembling of said induction module by low expenditure.

The object of the present invention is achieved by the induction module according to claim 1.

According to the present invention the induction module for an induction cooking hob comprises an induction coil carrier made of metal and a housing made of plastics, wherein:
the induction coil carrier is provided for supporting at least one induction coil,
the housing is provided for covering and/or enclosing the at least one induction coil,
the housing is fixed or fixable to a bottom side of the induction coil carrier,
the housing comprises a bottom wall, one or more side walls and an open top side,
at least one hook element is formed at one or more side walls of the housing,
the induction coil carrier includes a horizontal main panel,
the induction coil carrier includes at least one vertical sheet element extending downwards from the horizontal main panel,
at least one cut-out is formed in the vertical sheet element, and
the hook element and the corresponding cut-out form a snap-in mechanism for fixing the housing to the induction coil carrier, wherein
the side wall of the housing is adjacent to the corresponding vertical sheet element of the induction coil carrier.

The induction module according to the present invention can be assembled by low expenditure. The housing with the side walls allows a protection of the induction coils at the side. The induction module can be assembled without any tools and screws.

According to a preferred embodiment of the present invention the induction coil carrier includes at least one protruding element extending downwards from the horizontal main panel of the induction coil carrier, wherein the protruding element is provided for supporting the side wall of the housing.

Preferably, the protruding element is made by a U-shaped die-cut in the horizontal main panel of the induction coil carrier and by subsequent bending up a tongue-shaped element resulting from said U-shaped die-cut.

Alternatively, the protruding element is formed as a separate part fixed to the horizontal main panel of the induction coil carrier. In this case, the protruding element may be fixed to the induction coil carrier by rivets, welding, gluing or the like.

Further, the protruding elements may be provided for supporting two or more side walls of the housing.

Moreover, the housing may be additionally fixed to the induction coil carrier by at least one screw. This is advantageous for service reasons.

For example, the housing is fixable to the induction coil carrier by hanging up said housing at one side and clipping at one or more other sides.

Alternatively, the housing may be fixable to the induction coil carrier by clipping at all four sides.

In particular, at least one chamfer is formed at a lower edge of the vertical sheet element, so that the hook element can pass the lower edge of the vertical sheet element, when the housing is moved toward the induction coil carrier.

Furthermore, the open top side of the housing is covered by the horizontal main panel of the induction coil carrier.

Further, the present invention relates to an induction cooking hob comprising at least one induction module mentioned above.

Novel and inventive features of the present invention are set forth in the appended claims.

The present invention will be described in further detail with reference to the drawings, in which

FIG. 1 illustrates a schematic partial sectional side view of an induction module according to a preferred embodiment of the present invention,

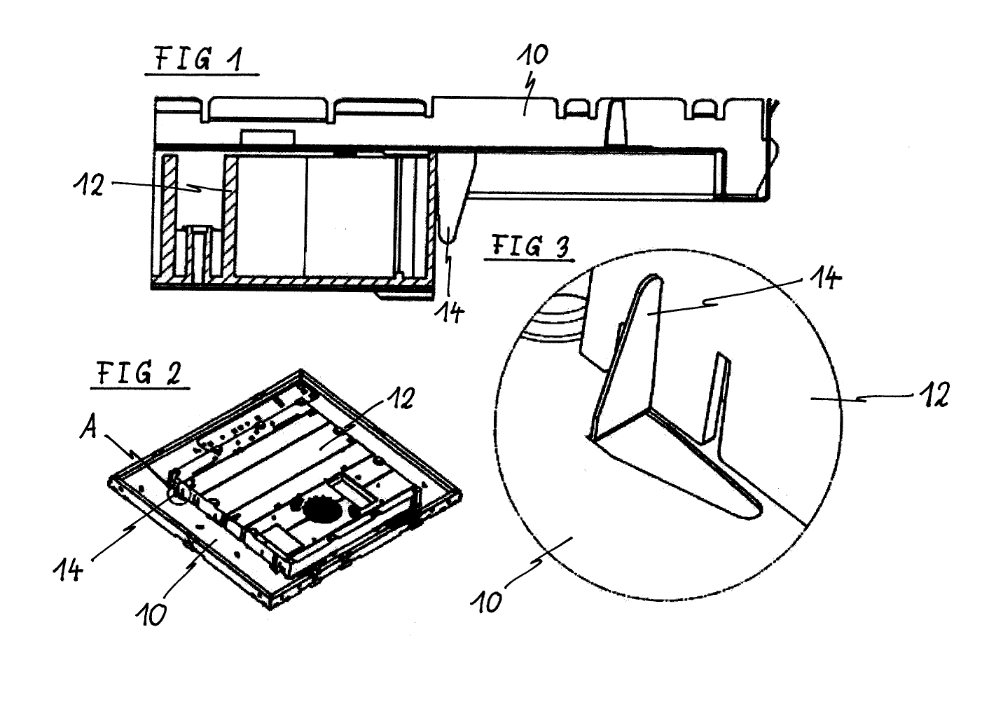

FIG. 2 illustrates a schematic perspective view at the bottom side of the induction module according to the preferred embodiment of the present invention,

FIG. 3 illustrates a schematic detailed perspective view of the induction module according to the preferred embodiment of the present invention,

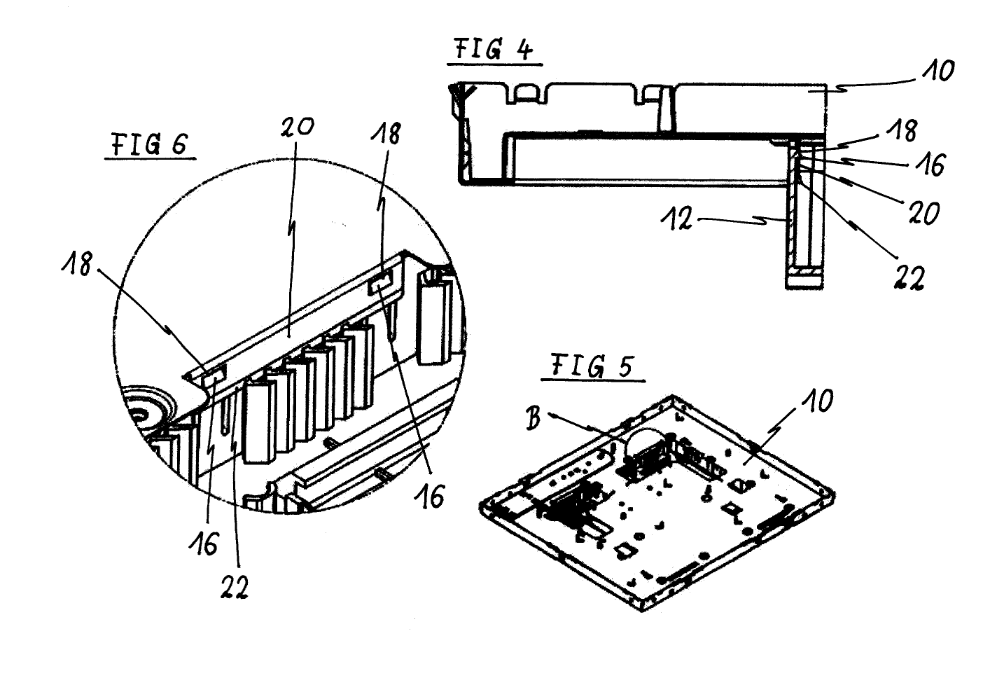

FIG. 4 illustrates a further schematic partial sectional side view of the induction module according to the preferred embodiment of the present invention,

FIG. 5 illustrates a schematic perspective view at the top side of the induction module according to the preferred embodiment of the present invention, and

FIG. 6 illustrates a schematic detailed perspective view of the induction module according to the preferred embodiment of the present invention.

FIG. 1 illustrates a schematic partial sectional side view of an induction module according to a preferred embodiment of the present invention.

The induction module comprises an induction coil carrier 10 and a housing 12. The housing 12 is fixed to the induction coil carrier 10. The induction coil carrier 10 is preferably made of steel, e.g. folded of a steel sheet. The housing 12 is preferably made of plastics. The induction coil carrier 10 is provided for supporting one or more induction coils. The housing 12 covers or encloses said induction coil or induction coils, respectively.

In particular, the induction coil carrier 10 includes one or more protruding elements 14. The protruding elements 14 extend downwards from a horizontal main panel of the induction coil carrier 10. The protruding elements 14 are provided for supporting the side walls of the housing 12.

In this example, the protruding element 14 is a bending up. The protruding element 14 is made by a U-shaped die-cut in the horizontal main panel of the induction coil carrier 10. Then the resulting tongue-shaped element is bended up and forms the protruding element 14. Alternatively, the protruding elements 14 may be separate parts fixed to the induction coil carrier 10. In the latter case, the protruding elements 14 may be fixed to the induction coil carrier 10 by rivets, welding, gluing or the like.

FIG. 2 illustrates a schematic perspective view at the bottom side of the induction module according to the preferred embodiment of the present invention.

The housing 12 is fixed at the bottom side of the induction coil carrier 10. The housing 12 is flat and has a rectangular base area. The housing 12 includes a bottom wall and four side walls. The open top side of the housing 12 is covered by the horizontal main panel of the induction coil carrier 10. The area of said horizontal main panel of the induction coil carrier 10 is bigger than the base area of the housing 12.

FIG. 3 illustrates a schematic detailed perspective view of the induction module according to the preferred embodiment of the present invention. Said detailed perspective view is an enlargement of the area A in FIG. 2.

FIG. 3 clarifies the geometric structure of the protruding element 14. Said protruding element 14 is the bending up from the horizontal main panel of the induction coil carrier 10. The protruding element 14 is made by the U-shaped die-cut in said main panel. The resulting tongue-shaped element has been bended up and forms the protruding element 14. The protruding element 14 supports the side wall of the housing 12.

FIG. 4 illustrates a further schematic partial sectional side view of the induction module according to the preferred embodiment of the present invention. Said further schematic sectional side view relates to another side wall of the housing 12 as in FIG. 1.

The housing 12 is fixed to the induction coil carrier 10. The side wall of the housing 12 includes a hook element 16. The induction coil carrier 10 includes a vertical sheet element 20 adjacent to said side wall of the housing 12. The vertical sheet element 20 includes a cut-out 18 for receiving the hook element 16 of the housing 12. In FIG. 4 the hook element 16 is received by the cut-out 18. The hook element 16 and the corresponding cut-out 18 form a snap-in mechanism for fixing the housing 12 to the induction coil carrier 10.

The induction module according to the present invention includes at least one hook element 16 and at least one corresponding cut-out 18. One or more side walls of the housing 12 include one or more hook elements 16. When assembling the induction module, the housing 12 can be hung-up at one side and clipped to the induction coil carrier 10 at one or more of the other sides. Alternatively, the housing 12 can be clipped to the induction coil carrier 10 at all four sides.

Further, the induction module according to the present invention includes one or more protruding elements 14 at two or more sides. The at least one hook element 16 and corresponding cut-out 18 as well as the protruding elements 14 allow the fixation of the housing 12 to the induction coil carrier 10 without any tools and screws.

In this example, a chamfer 22 is provided at the lower edge of the vertical sheet element 20. The chamfer 22 allows that the hook element 16 can easily pass the lower edge of the vertical sheet element 20, when the housing 12 is pushed towards the induction coil carrier 10.

FIG. 5 illustrates a schematic perspective view at the top side of the induction module according to the preferred embodiment of the present invention. The housing 12 is fixed at the bottom side of the induction coil carrier 10 and is therefore not visible in FIG. 5.

FIG. 6 illustrates a schematic detailed perspective view of the induction module according to the preferred embodiment of the present invention. Said detailed perspective view is an enlargement of the area B in FIG. 5.

The section shown in FIG. 6 comprises two hook elements 16 and two corresponding cut-outs 18. Said hook elements 16 are formed at one side wall of the housing 12. The two cut-outs 18 are formed in one vertical sheet element 20 of the induction coil carrier 10. The hook elements 16 are received by the corresponding cut-outs 18. The chamfer 22 is provided at the lower edge of the vertical sheet element 20. The chamfer 22 allows that the hook element 16 can easily pass the lower edge of the vertical sheet element 20, when the housing 12 is pushed against the induction coil carrier 10.

Although an illustrative embodiment of the present invention has been described herein with reference to the accompanying drawings, it is to be understood that the present invention is not limited to that precise embodiment, and that various other changes and modifications may be affected therein by one skilled in the art without departing from the scope or spirit of the invention. All such changes and modifications are intended to be included within the scope of the invention as defined by the appended claims.

### LIST OF REFERENCE NUMERALS

10 induction coil carrier
12 housing
14 protruding element
16 hook element
18 cut-out
20 vertical sheet element
22 chamfer

1. An induction module for an induction cooking hob comprising an induction coil carrier (10) made of metal and a housing (12) made of plastics, wherein:
the induction coil carrier (10) is provided for supporting at least one induction coil,
the housing (12) is provided for covering and/or enclosing the at least one induction coil,
the housing (12) is fixed or fixable to a bottom side of the induction coil carrier (10),
the housing (12) comprises a bottom wall, one or more side walls and an open top side,
at least one hook element (16) is formed at one or more side walls of the housing (12),
the induction coil carrier (10) includes a horizontal main panel,
the induction coil carrier (10) includes at least one vertical sheet element (20) extending downwards from the horizontal main panel,
at least one cut-out (18) is formed in the vertical sheet element (20), and
the hook element (16) and the corresponding cut-out (18) form a snap-in mechanism for fixing the housing (12) to the induction coil carrier (10), wherein
the side wall of the housing (12) is adjacent to the corresponding vertical sheet element (20) of the induction coil carrier (10).

2. The induction module according to claim 1,
characterized in that
the induction coil carrier (10) includes at least one protruding element (14) extending downwards from the horizontal main panel of the induction coil carrier (10), wherein the protruding element (14) is provided for supporting the side wall of the housing (12).

3. The induction module according to claim 2,
characterized in that
the protruding element (14) is made by a U-shaped die-cut in the horizontal main panel of the induction coil carrier (10) and by subsequent bending up a tongue-shaped element resulting from said U-shaped die-cut.

4. The induction module according to claim 2,
characterized in that
the protruding element (14) is formed as a separate part fixed to the horizontal main panel of the induction coil carrier (10).

5. The induction module according to claim 4,
characterized in that
the protruding element (14) is fixed to the horizontal main panel of the induction coil carrier (10) by rivets, welding or gluing.

6. The induction module according to claim 2,
characterized in that
the protruding elements (14) are provided for supporting two or more side walls of the housing (12).

7. The induction module according to claim 1,
characterized in that
the housing (12) is additionally fixed to the induction coil carrier (10) by at least one screw.

8. The induction module according to claim 1,
characterized in that
the housing (12) is fixable to the induction coil carrier (10) by hanging up said housing (12) at one side and clipping at one or more other sides.

9. The induction module according to claim 1, characterized in that
the housing (12) is fixable to the induction coil carrier (10) by clipping at all four sides.

10. The induction module according to claim 1, characterized in that
at least one chamfer (22) is formed at a lower edge of the vertical sheet element (20), so that the hook element (16) can pass the lower edge of the vertical sheet element (20), when the housing (12) is moved toward the induction coil carrier (10).

11. The induction module according to claim 1, characterized in that
the open top side of the housing (12) is covered by the horizontal main panel of the induction coil carrier (10).

12. An induction cooking hob comprising at least one induction module, characterized in that
the induction cooking hob comprises at least one induction module according to claim 1.
